(19) United States
(12) Patent Application Publication
(10) Pub. No.: US 2006/0207948 A1
(43) Pub. Date: Sep. 21, 2006

(54) Filter assemblies and methods

(76) Inventors: John R. Hacker, Edina, MN (US); David B. Harder, Burnsville, MN (US); Brent A. Gulsvig, Faribault, MN (US)

Correspondence Address: MERCHANT & GOULD PC, P.O. BOX 2903, MINNEAPOLIS, MN, 55402-0903, US

(21) Appl. No.: 10/543,238

(22) PCT Filed: Jan. 27, 2004
(86) PCT No.: PCT/US04/02074

§ 371 Date: Apr. 3, 2006

Related U.S. Application Data
(60) Provisional application No. 60/443,303, filed on Jan. 28, 2003.
(60) Provisional application No. 60/458,215, filed on Mar. 27, 2003.

(51) Int. Cl. B01D 37/00

(52) U.S. Cl. 210/791

(57) ABSTRACT

A fluid filter assembly includes a housing, a service cover, a center tube removably secured to the service cover, a filter cartridge removably sealed and circumscribing the center tube, and a seal arrangement. The seal arrangement is between the center tube and portions of the housing to close a drainage channel to the flow of clean fluid flow therethrough, when the fluid filter assembly is operating to filter. During normal operation, the fluid filter assembly operates to allow fluid to flow into the housing through an inlet channel, through the filter cartridge, through openings in the center tube, and out of the housing through the outlet channel. Methods for servicing include removing a service cover from a housing to remove, together with the service cover, a center tube, and open a drainage flow passageway from the housing. Next a filter cartridge is removed from the center tube, and a new filter cartridge is operably mounted on the center tube. Next, the service cover with the center tube having the new filter cartridge is operably mounted in the housing to close the drainage flow passageway. Methods of filtering will direct fluid to be filtered into a housing having a removable and replaceable filter cartridge; then direct the fluid through a tubular region of filter media in the cartridge; then through fluid openings in a center tube; and into a clean fluid flow passageway. Example methods include preventing fluid to bypass the filter media by removably sealing the filter cartridge to the center tube. Example methods will also include preventing fluid from flowing into a drainage passageway by removably sealing the center tube to other portions of the filter housing. Systems utilize filter assemblies as characterized herein include fuel systems, lube systems, and hydraulic systems.

### TECHNICAL FIELD

This disclosure relates to fluid filters for use in hydraulic systems, lube systems, and fuel systems. In particular examples, this disclosure concerns apparatus and methods for allowing the servicing or access to fluid filter arrangements from a position over or above whatever part that remains fixed to the rest of the system in operational position during servicing.

### BACKGROUND

Filters are commonly used in connection with lubrication systems and fuel systems for internal combustion engines, and hydraulic systems for heavy duty equipment. Filters are also used in many other types of fluid systems, for example, a variety of industrial filtration applications. In these types of systems, the filter is “serviced” periodically by either replacing the entire filter, or by replacing only a portion of the filter that wears out (a filter cartridge, for example).

Accessing and servicing filter systems continually presents problems in the areas of convenience, ease of assembly, and reducing the amount of waste produced. If it is not convenient to access the filter, or easy to service, the person may wait too long to service the filter, which jeopardizes the systems for which the filter is being used. If too much of the filter is disposed of in a way that cannot be recycled or incinerated, the environment can suffer. Therefore, improvements in providing convenient, easily accessible, easily assembled, and environmentally friendly filters are desirable.

### SUMMARY

A fluid filter assembly is provided including a housing, a service cover, a center tube removably secured to the service cover, a filter cartridge removably sealed and circumscribing the center tube, and a seal arrangement. The seal arrangement is provided between the center tube and portions of the housing to close a drainage channel to the flow of clean fluid flow therethrough, when the fluid filter assembly is operating to filter. During normal operation, the fluid filter assembly operates to allow fluid to flow into the housing through an inlet channel, through the filter cartridge, through openings in the center tube, and out of the housing through the outlet channel.

Methods for servicing fluid filter assemblies are provided. Convenient methods described include removing a service cover from a housing to remove, together with the service cover, a center tube, and open a drainage flow passageway from the housing. Next, a filter cartridge is removed from the center tube, and a new filter cartridge is operably mounted on the center tube. Next, the service cover with the center tube having the new filter cartridge is operably mounted in the housing to close the drainage flow passageway.

Methods of filtering will preferably utilize the principles described herein for constructing filter assemblies. Preferred methods of filtering will direct fluid to be filtered into a housing having a removable and replaceable filter cartridge; then directing the fluid through a tubular region of filter media in the cartridge; then through fluid openings in a center tube; and into a clean fluid flow passageway. Preferred methods include preventing fluid to bypass the filter media by removably sealing the filter cartridge to the center tube. Preferred methods will also include preventing fluid from flowing into a drainage passageway by removably sealing the center tube to other portions of the filter housing.

Systems utilize filter assemblies as characterized herein are described. Such systems can include fuel systems, lube systems, and hydraulic systems.

### BRIEF DESCRIPTION OF THE DRAWINGS

FIG. 1 is a schematic depiction of a piece of equipment with an engine having a fuel system, a lube system, and a hydraulic system, utilizing filter assemblies constructed according to principles of this disclosure;

FIG. 2 is a schematic, side elevation view of a first embodiment of a filter assembly constructed according to principles of this disclosure;

FIG. 3 is a top plan view of the filter assembly depicted in FIG. 2;

FIG. 4 is a schematic, exploded, perspective view of the filter assembly depicted in FIGS. 2 and 3;

FIG. 5 is a schematic, cross-sectional view of the filter assembly depicted in FIGS. 2-4; the cross-section being taken along the line 5-5 of FIG. 3;

FIG. 6 is a further schematic, cross-sectional view of the filter assembly depicted in FIGS. 2-5; the cross-section being taken along the line 6-6 of FIG. 3;

FIG. 7 is a perspective view of a second embodiment of a filter assembly constructed according to principles of this disclosure;

FIG. 8 is another perspective view of the filter assembly depicted in FIG. 7;

FIG. 9 is an exploded, perspective view of the filter assembly depicted in FIGS. 7 and 8;

FIG. 10 is a schematic, cross-sectional view of the filter assembly depicted in FIGS. 7-9;

FIG. 11 is another schematic, cross-sectional view of the filter assembly depicted in FIGS. 7-10;

FIG. 12 is a schematic, cross-sectional view of the filter assembly depicted in FIGS. 7-11 and during servicing of the filter assembly,

FIG. 13 is a top, perspective view of one embodiment of a center tube used with the filter assembly of FIGS. 7-12;

FIG. 14 is a bottom, perspective view of the center tube depicted in FIG. 13;

FIG. 15 is a perspective view of a third embodiment, this embodiment showing filter assemblies of the type depicted in FIGS. 2-12 and joined to an engine crankcase filter assembly;

FIG. 16 is a front elevational view of the assembly depicted in FIG. 15; and

FIG. 17 is a schematic, cross-sectional view of the assembly depicted in FIGS. 15 and 16.

### DETAILED DESCRIPTION

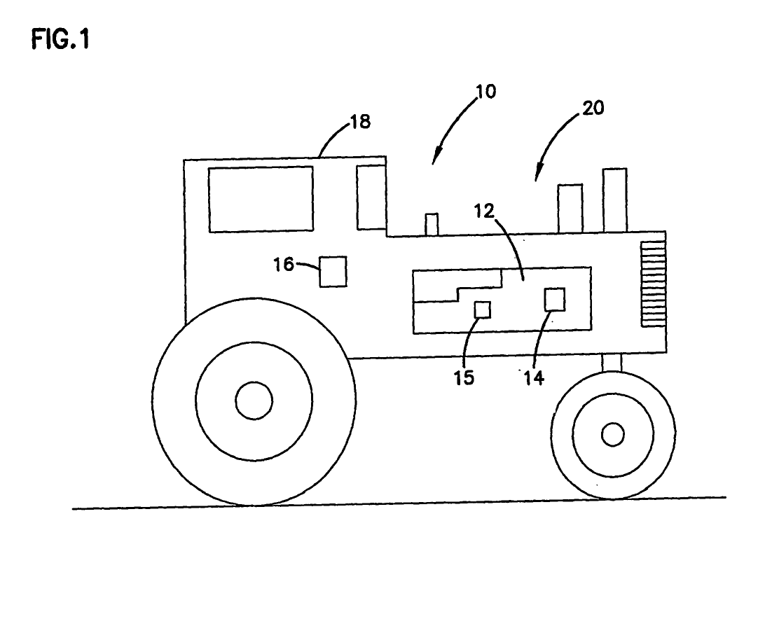

First, attention is directed to FIG. 1. FIG. 1 is a schematic depiction of equipment 10 including an engine 12. The equipment 10 includes a lubrication system 14, a fuel system 15, and a hydraulic system 16. The lubrication system 14, the fuel system 15, and the hydraulic system 16 will need to have a fluid in the system (oil, fuel, or hydraulic fluid) cleaned. To provide the cleaning function, a fluid filter assembly 20 is utilized. In the example embodiment shown in FIG. 1, there are three fluid filter assemblies 20 shown, one for the lubrication system 14, one for the fuel system 15, and one for the hydraulic system 16. Equipment 10 shown in FIG. 1 is a tractor 18. The fluid filter assembly 20 is useable with other types of equipment including bulldozers, skid steers, payloaders, mining equipment, over-the-highway trucks, off-road trucks, and combines. Other types of equipment, including industrial filtration, generators, etc., also can use filter assemblies and methods as characterized herein.

For the systems described herein, mobile hydraulic filters will have operating pressures generally between −7 psi to 700 psi. Operating pressures for an engine lube system will be 40 psi-80 psi, with compressor lube systems being about 250 psi. For fuel systems, if the pressure is on the upstream side of the pump, it will be under vacuum pressure of about −10 psi. If used as a secondary filter, on the downstream side of the pump, the operating pressures will be about 60 psi. In industrial hydraulic applications, the pressures are generally high, such as up to 6,000 psi. Of course, the pressures can vary, and these are simply examples.

The fluid filter assemblies 20 characterized herein are particularly convenient for use in a “top-load” orientation. By the term “top-load”, it is meant that the filter assembly 20 is installed in an orientation that permits servicing or access to the filter assembly 20 from a position over or above whatever part that remains fixed to the equipment (e.g., engine, or generator, or whatever is the applicable machine part) in operational position during servicing, when the equipment is in normal, operable orientation. In many convenient top-load configurations of the type that are characterized herein, the person servicing the filter assembly 20 is not required to be in a position underneath or below the equipment. Instead, the person servicing the filter assembly 20 is able to access it from the top of the equipment. For example, in a vehicle having an engine that is selectively accessible by a moveable hood, the filter assembly 20 would be accessible merely by raising the hood of the vehicle and then removing a service cover. It should be understood that alternate orientations of the filter assembly 20 can also be used, but a top load orientation is convenient and preferred.

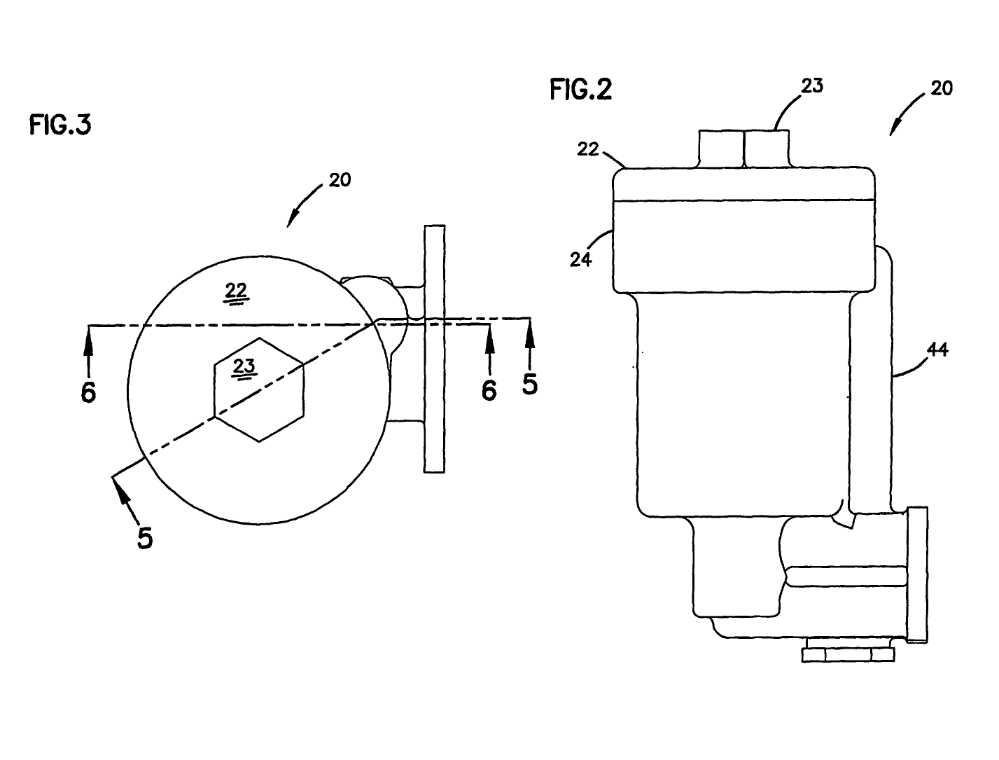

### A. The Filter Assemblies of FIGS. 2-6

Attention is first directed to the embodiment of the filter assembly 20 shown in FIGS. 2-6. The filter assembly 20 is illustrated in a top load configuration. In the embodiment shown, the filter assembly 20 includes a service cover 22 and a housing 24. The service cover 22 is removable and remountable onto the housing 24. Usually, there is a threaded engagement 26 between the service cover 22 and the housing 24, although other types of connections are useable. In FIGS. 2-4, a nut 23 can be seen on top of the service cover 22. The nut 23 can be manipulated with a hand tool, such as a wrench, in order to threadably remove the service cover 22 from the housing 24.

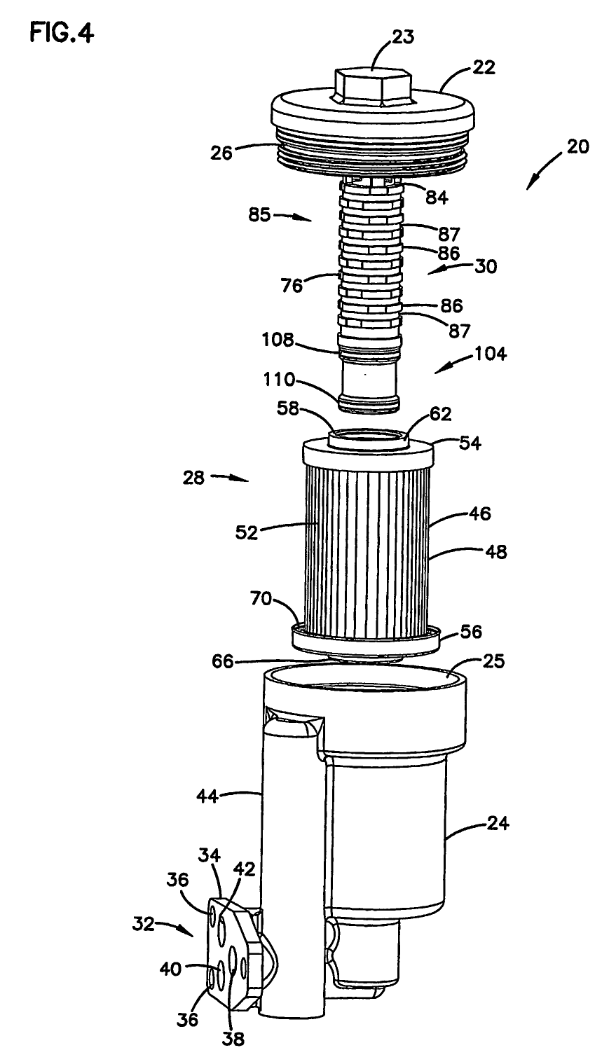

In FIG. 4, the basic pieces of the filter assembly 20 are shown. The filter assembly 20 includes a removable and replaceable filter cartridge 28, which is removably mountable onto a center tube 30. By use of the term “center”, it is not meant that the center tube must necessarily be within the geometric center of the filter assembly 20; rather, the center tube 30 is given that name for convenience and because there is the filter cartridge 28 mounted to circumscribe it. The center tube 30 does not necessarily have to be within the geometric center of the filter cartridge 28.

Still in reference to FIG. 4, it can be seen that the housing 24 is configured to allow for inflow and outflow of fluid into an interior 25 of the housing through an inlet and outlet arrangement 32. The inlet and outlet arrangement 32 extends within, in the embodiment shown, a mounting flange 34. The mounting flange 34 includes apertures 36 for mounting.

The inlet and outlet arrangement 32 includes an inlet port 38 for receiving fluid to be filtered; an outlet port 40 for providing an exit from the housing 24 for cleaned fluid; and a drainage port 42 to allow for the draining of fluid during servicing.

Also viewable in FIG. 4, it can be seen that the inlet port 38 is in fluid flow communication with an inlet channel 44, the exterior portion of which is shown in FIG. 4.

Still in reference to FIG. 4, the filter cartridge 28 is shown in perspective view. In the embodiment shown in FIG. 4, the filter cartridge 28 has a region of filter media 46 arranged, in this embodiment, in a cylindrical fashion to have an upstream side 48 and a downstream side 49 (FIG. 5) within the open tubular volume 50 (FIG. 5). The media 46 can be many different types of media, depending upon the particular filtration system. In many instances, the media 46 is pleated media 52. The pleated media 52 can be cellulose, synthetic, or blends thereof, again, depending upon the application.

The filter cartridge 28 illustrated in FIG. 4 has first and second end caps 54, 56, with the pleated media 52 extending therebetween. Adjacent to and integral with first end cap 54 is a seal member 58. The seal member 58 forms a portion of a sealing arrangement 60 that provides a seal 61 (FIG. 5) with the center tube 30. In the embodiment shown, and depicted in FIG. 5, the seal member 58 is held by a ring 62 that is preferably integral with the end cap 54 and projecting above the end cap 54.

Similarly, in this particular embodiment, there is a second seal member 64 that is adjacent to the second end cap 56 to provide a seal 65 with the center tube 30. The second seal member 64 is held by a ring 66 that extends, in this embodiment, integral with and below the end cap 56. It should be appreciated that the sealing arrangement 60 prevents fluid from bypassing the filter media 46 to get to the open tubular volume 50 on the downstream side 49 of the media 46. The sealing arrangement 60 also holds the filter cartridge 28 onto the center tube 30. This is useful during servicing so that when the service cover 22 is removed with the center tube 30 (as explained below), the filter cartridge 28 is also removed with the service cover 22 and center tube 30.

Circumscribing an outer perimeter of the bottom end cap 56 is a second region of filter media 70. The second region of filter media 70 operates to clean or strain the fluid that is in an unfiltered liquid volume between the inside wall of the housing 24 and the upstream side 48 of the filter media 46 during servicing. That is, during servicing, when the service cover 22 is removed, removing with it the center tube 30 and filter cartridge 28, the fluid in the unfiltered liquid volume 72 flows through the second region of media 70 in order to catch any particulate or debris. In convenient implementations, the second region of media 70 is the same type of media used for the region of media 46; of course, other types of media are useable.

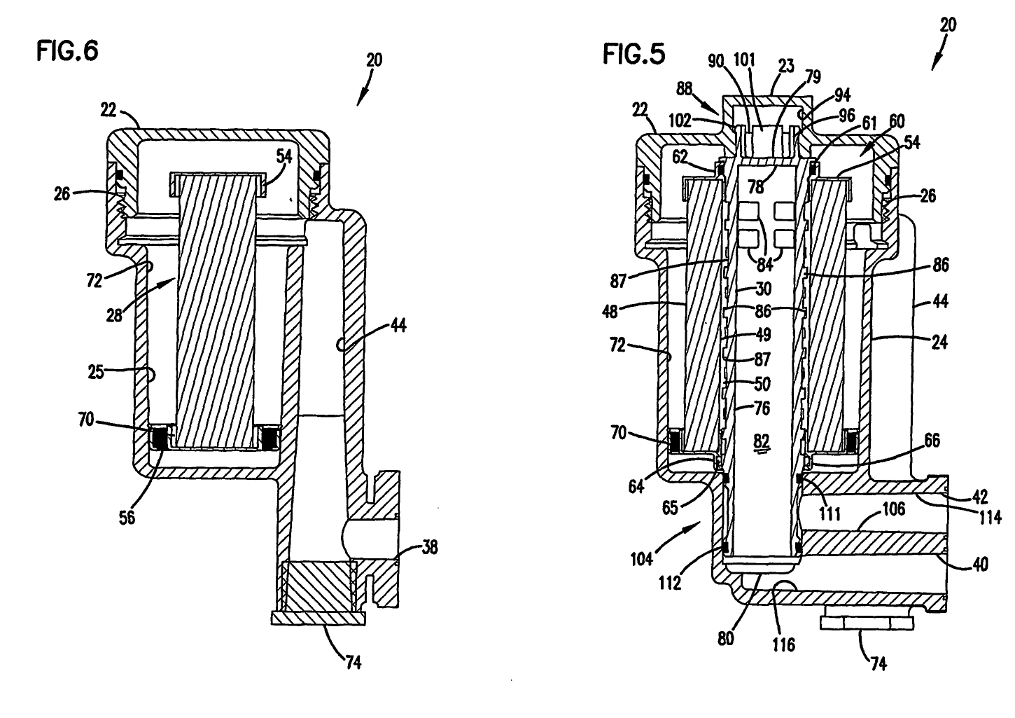

Turning now to the cross-sections shown in FIGS. 5 and 6, other operational details are illustrated. The inlet channel 44 can be seen in longitudinal extension going from the inlet port 38 to the unfiltered liquid volume 72 within the housing 24. A removable plug 74 is shown terminating the bottom of the inlet channel 44. Fluid to be filtered enters into the filter assembly 20 by flowing through the inlet port 38, through the inlet channel 44, and into the unfiltered liquid volume 72.

In FIG. 5, the center tube 30 can be seen in greater detail. The center tube 30, in the illustrated embodiment, has a side wall 76 extending between a closed end 78 and an open end 80. The side wall 76 defines an open fluid flow channel 82. The open fluid flow channel 82 extends from the end wall 79 forming the closed end 78 to the open end 80. During normal operation of the filter assembly 20, the open fluid flow channel 82 is in fluid flow communication between the open end 80 and the outlet port 40.

The side wall 76 of the center tube 30 is constructed of a fluid impermeable material, to prevent the transmission of flow therethrough. A portion of the side wall 76 defines flow apertures 84 therethrough to allow the flow of fluid through the side wall 76 and into the open fluid flow channel 82. In the embodiment shown in FIG. 5, the apertures 84 are located in the upper one-third portion of the overall length of the center tube 30. As can be seen in FIG. 5, the length of the center tube 30 is longer than the length of the filter cartridge 28.

In the illustrated embodiment, the center tube 30 includes media-supporting standoffs 85 (FIG. 4). In the embodiment shown, the media-supporting standoffs 85 are shown as a plurality of raised surfaces 86, raised relative to a remaining portion 87 of the center tube 30. The media-supporting standoffs 85 functions to support the filter media 46. Also, due to the raised surfaces 86 relative to the remaining portion 87, filtered fluid (that is, fluid that has passed through the filter media 46) is allowed to collect in the open tubular volume 50, between the downstream side 49 of the media 46 and the side wall 76 of the center tube 30, before flowing through the apertures 84 in the center tube 30.

By reviewing FIG. 5, it should be apparent that fluid to be cleaned flows from the unfiltered liquid volume 72 through the filter media 46 and into the open tubular volume 50, between the downstream side 49 of the media 46 and the side wall 76 of the center tube 30. The cleaned fluid is allowed to flow into the open fluid flow channel 82 by passing through the aperture 84. From there, the cleaned fluid flows through the open end 80 of the center tube 30 and out through the outlet port 40.

The filter assembly 20 includes structure to ensure that the center tube 30 is removed from the housing 24 when the service cover 22 is removed from the housing 24. In the embodiment shown, the structure is shown as a snap-ring arrangement 88. The snap-ring arrangement 88 provides for mechanical connection between the service cover 22 and the center tube 30, such that when the service cover 22 is moved away from the housing 24, the center tube 30 is also moved from the housing 24. Further, in preferred arrangements, the snap-ring arrangement 88 is constructed and arranged to ensure that when the service cover 22 is rotated relative to the housing 24, the center tube 30 does not rotate but, rather, stays stationary. In the embodiment shown, the snap-ring arrangement 88 includes an internally directed slide edge or ring 90 on the inside portion of the service cover 22. The slide ring 90 is engaged by a grasping arrangement 94 on the center tube 30. In the embodiment shown, the grasping arrangement 94 includes at least one hooked flange 96. In the preferred implementation, the grasping arrangement 94 includes a plurality of, such as four, hooked flanges 96 extending from the end wall 79 of the center tube 30. The hooked flanges 96 include a cantilevered flange 101 extending from the end wall 79 and terminating at a hook 102 which engages the slide ring 90. As the service cover 22 is rotated about the threaded engagement 26, the slide ring 90 slides relative to the hooks 102. This allows the service cover to rotate while the center tube 30 and filter cartridge 28 remain stationary.

In accordance to principles of this disclosure, the filter assembly 20 is constructed and arranged to provide that the center tube 30 has a sealing arrangement 104 to provide for the selective opening or closing of the drainage flow passageway, shown in FIG. 5 at 106. The drainage flow passageway terminates at drainage port 42. Depending upon the type of filtration system that the filter 20 is used within, the drainage port 42 leads to a variety of tanks, typically low pressure tanks, when compared to the path that the outlet port 40 leads to. For example, in a fuel system, the drain flow passage 106 and drainage port 42 leads to the fuel tank. In lube systems, the drainage port 42 returns to the crankcase. In hydraulic systems, the drainage port 42 leads to the hydraulic fluid holding reservoir.

In preferred embodiments, the sealing arrangement 104 used with the center tube 30 will provide that when the center tube 30 is removed from the housing 24 during servicing, the seal arrangement 104 is released to open the drainage flow passageway 106 and allow liquid within the housing interior 25 to drain through the drain flow passageway 106. In FIG. 4, the sealing arrangement 104 includes a first seal member 108 mounted on and around the center tube 30 and a second seal member 110 mounted on and around the center tube 30. The first seal member 108 and second seal member 110 create seals at 111, 112 (FIG. 5) between the center tube 30 and portions of the housing 24. In the embodiment shown in FIG. 5, the seals 111, 112 are formed with the portion of the housing 24 that is immediately adjacent to the cavity 114 that defines the drain flow passageway 106.

In FIG. 5, it can be seen that the arrangement illustrated shows an outlet flow passageway 116, which leads to the outlet port 40, oriented below and parallel to the drainage flow passageway 106. Of course, many embodiments of the flow passageways can be made. In this arrangement, during normal filtering operation, clean fluid passes out through the open end 80 of the center tube 30 and into the outlet flow passageway 116. The cleaned fluid is prevented from flowing into the drainage flow passageway 106 because of the seals 111, 112. During servicing, however, the service cover 22 is removed, and the center tube 30 is removed from the housing together with the service cover 22. When the seals 111, 112 are released, fluid within the housing interior 25 starts to flow through the drainage flow passageway 106. Some of the fluid may also flow through the outlet flow passageway 116, but the outlet flow passageway 116 leads to a higher pressure region than the drainage flow passageway 106. Because of this difference in pressures, most of the fluid will drain quickly to the drainage flow passageway 106.

Operation and servicing of the filter assembly 20 is provided as follows. Fluid to be filtered enters the filter assembly 20 through the inlet port 38, flowing through the inlet channel 44, and enters the housing interior 25. The unfiltered fluid occupies the volume 72 between the wall of the housing 24 and the upstream side 48 of the filter media 46. The fluid then flows through the pleated media 52, where contaminant and debris is removed. From there, the fluid enters into the filtered fluid volume 50 that is between the downstream side 49 and the outer wall of the center tube 30. The filtered fluid then flows through the apertures 84 of the center tube and into the open fluid flow channel 82. The filtered liquid exits the open fluid flow channel 82 in the center tube 30 through the open end 80, flows through the outlet flow passageway 116, and exits the filter assembly through the outlet port 40. During filtering operations, the fluid is not allowed to flow through the drainage flow passageway 106 due to the existence of the seals 111, 112.

After a period of use, the filter cartridge 28 will need replacement. The filter assembly 20 is serviced. The filter assembly 20 is preferably serviced in a top load orientation. That is, the filter assembly 20 is accessed from above whatever equipment upon which it is mounted. The service cover 22 is loosened, by placing a tool onto the nut 23, rotating, and releasing the threaded engagement 26 between the cover 22 and the housing 24. While the service cover 22 is rotated, the center tube 30 with the filter cartridge 28 attached thereto, is moved linearly, but not rotationally. This is due to the interaction of the slide ring 90 and the grasping arrangement 94 on the snap-ring arrangement 88. As the service cover 22 is rotated, there is relative sliding motion between the service cover 22 and the hooked flanges 96 secured to the center tube 30 so that the center tube 30 does not rotate.

As the threaded engagement 26 is released and the service cover 22 and center tube 30 (with the filter cartridge 28 sealingly secured thereto), the service cover 22 and center tube 30 moves linearly or axially away from the housing 24. Eventually, this releases the seals 111, 112 between the center tube 30 and the housing 24. As soon as these seals 111, 112 are released, fluid within the housing interior 25 flows into the drainage flow passageway 106. Any of the fluid in the housing interior 25 on the upstream side 48 of the media 46 (in the unfiltered fluid volume 72) is forced to pass through the second region of media 70, where it is filtered. This ensures that any fluid that gets to the outlet flow passage 116 has been filtered for particulate.

Eventually, the entire service cover 22 is totally removed from the housing 24. The service cover 22 will have the center tube 30 attached to it. Attached to the center tube 30 will be the filter cartridge 28. The filter cartridge 28 is then pulled off of the center tube 30, releasing the seals 61, 65. A new, second filter cartridge 28 is then placed onto the center tube 30 by sliding it over the open end 80 of the center tube 30. Seals 61, 65 are created between the new filter cartridge 28 and the center tube 30.

The service cover 22 with the center tube 30 and the new filter cartridge 28 is then mounted into the filter housing 24. This is done by placing the center tube 30 into the housing interior 25 with the open end 80 going in first. The service cover 22 is again rotated relative to the housing 24 to engage the threaded engagement 26. Eventually, the seals 111, 112 are formed between the center tube 30 and the housing 24. Once the seals 111, 112 have been formed to close the drain flow passageway 106, the filter assembly 20 is again ready for use.

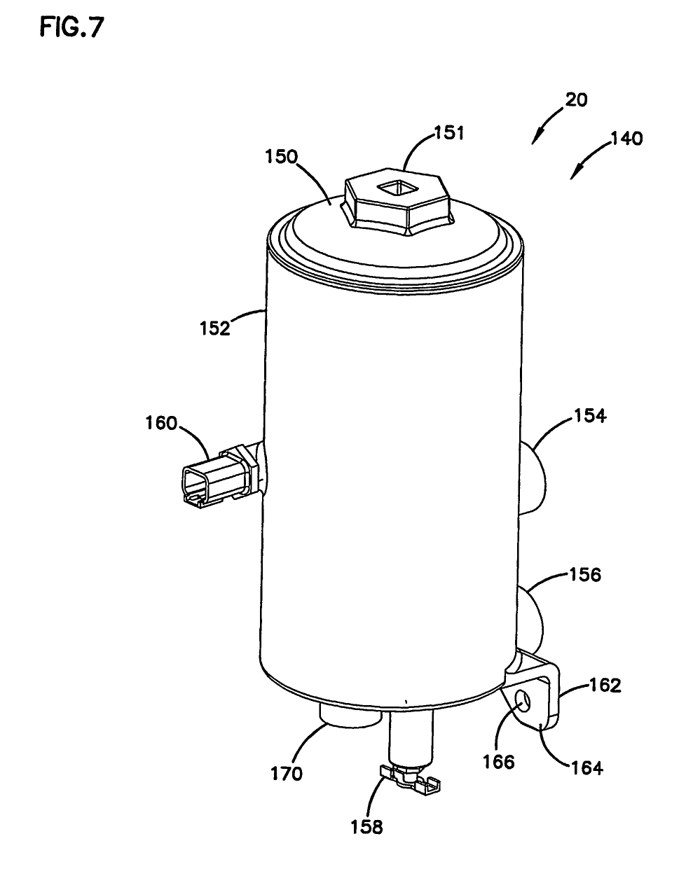

### B. The Embodiments of FIGS. 7-14

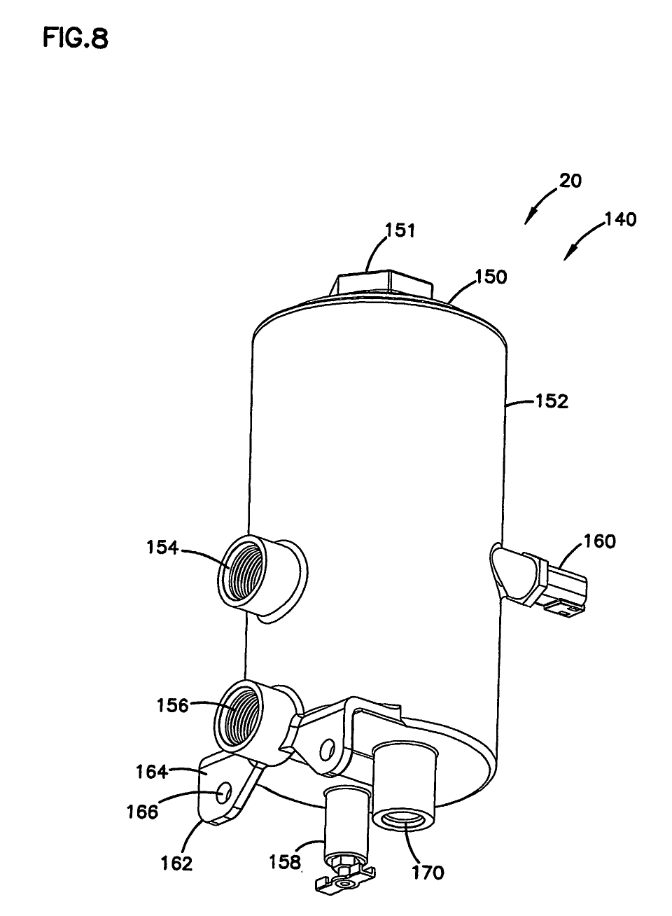

Attention is now directed to another embodiment of filter assembly 20. Filter assembly 20 is also preferably convenient for use in a top load orientation. The filter assembly 20 depicted in FIGS. 7-10 can be used in a variety of systems, such as fuel systems, lube systems, and hydraulic systems. The example illustrated is particularly useful in a fuel system and will be described as a fuel filter assembly 140. The filter assembly 140 is illustrated in perspective view, from the exterior, in FIGS. 7 and 8. The filter assembly 140 includes a service cover 150, a housing 152, an inlet port 154, and an outlet port 156. Because this embodiment is illustrated as a fuel filter assembly 140, there are features that are especially convenient for use as a fuel filter assembly 140. This embodiment illustrates a drain valve 158 for allowing for the convenient draining of water that has collected in the housing 152 from the filter assembly 140. Also shown is a water level sensor 160 projecting from the exterior of the housing 152. The water level sensor 160 can be monitor such that when the level of water collected within the housing 152 reaches a certain level, the drain valve 158 is opened, and the water collected within the housing 152 is drained.

Also shown in FIGS. 7 and 8 is a mounting assembly 162 projecting from the housing 152. The mounting assembly 162 includes a flange 164 defining mounting apertures 166 for the receipt of fasteners or bolts to allow for the fuel filter assembly 140 to be properly mounted for use in a system.

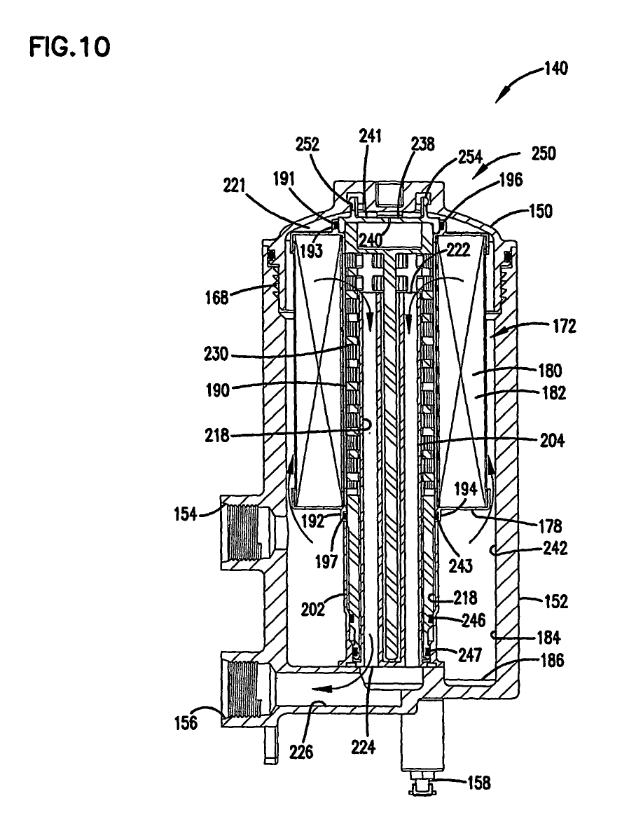

A nut 151 projects from the top of the service cover 150 to allow for selective removal and reattachment of the service cover 150 to the housing 152 through a threaded engagement 168 (FIG. 10).

FIGS. 7 and 8 also show the drain port 170. The drain port 170 allows for the quick and convenient draining of the fluid within the housing 152 during servicing. When the assembly shown in FIGS. 7-12 is used as fuel filter assembly 140, the drain port 170 leads to a fuel pump.

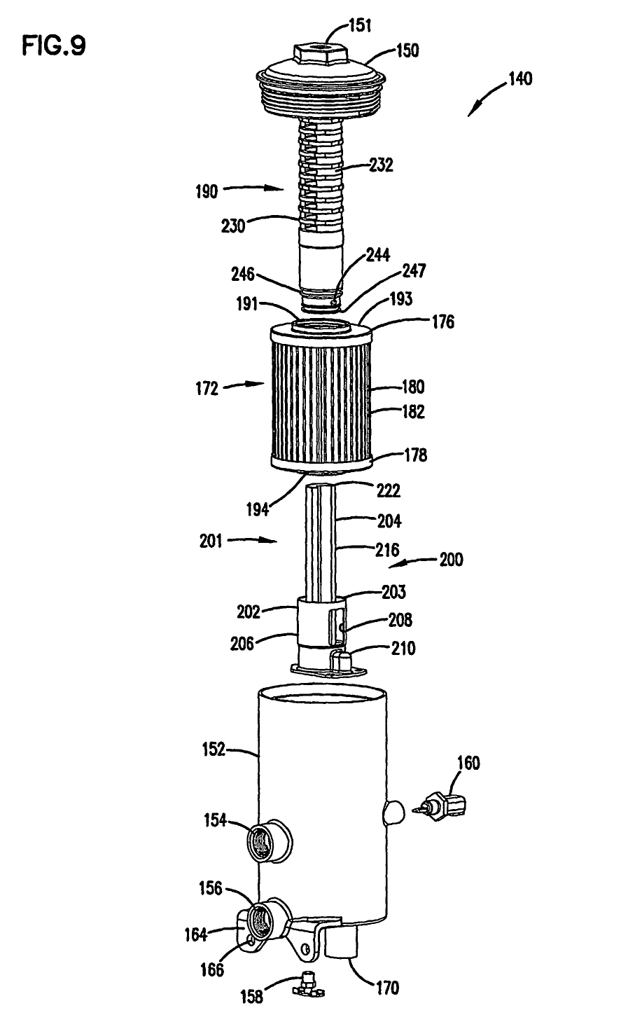

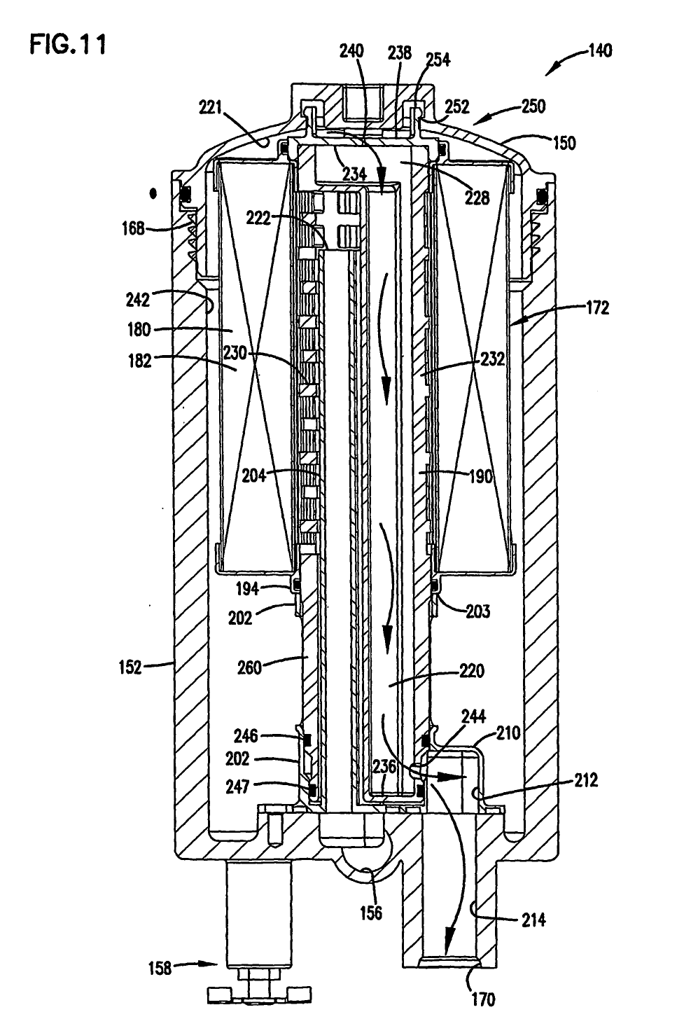

Turning now to FIGS. 9 and 10, the fuel filter assembly 140 is depicted in exploded perspective view (FIG. 9) and in assembled cross-sectional view (FIGS. 10 and 11). The fuel filter assembly 140 includes a filter cartridge 172 that is similar to, but not identical to, the example filter cartridge 28 of the first embodiment. The filter cartridge 172 in this embodiment does not have a second region of media, such as media region 70 circumscribing the arrangement. The fuel filter assembly 140 has other arrangements in order to ensure that only cleaned fluid is allowed to flow through the cleaned fluid outlet port 156. This is explained further below.

The filter cartridge 172 of FIG. 9 has first and second end caps 176, 178 with a region of filter media 180 extending therebetween. The filter media 180, in the embodiment shown, is pleated media 182. When the assembly is used as a fuel filter assembly 140, the media 180 is selected for fuel filters and can be cellulose, synthetic, or blends thereof. Fuel filter media is usually of high efficiency and is treated to separate water from the fuel. In FIG. 10, it can be seen there is a cavity 184 between the second or bottom end cap 178 and the bottom 186 of the housing 152. This cavity 184 allows for the collection of water that has been separated from the fuel. As mentioned above, the water level sensor 160 is oriented to detect the level of water in the cavity 184, and then can be conveniently drained through the drain valve 158.

As with the first embodiment, the filter cartridge 172 has a sealing arrangement 188 that allows for sealing engagement between the filter cartridge 172 and a center tube 190. The sealing arrangement 188 is implemented in this embodiment analogously to the arrangement 60 of filter cartridge 28. That is, there are first and second seal members 191, 192 held within rings 193, 194 that are immediately adjacent to the end caps 176, 178. The seal members 191, 192 form releasable seals 196, 197 between the filter cartridge 172 and the center tube 190.

Still in reference to FIGS. 9 and 10, the fuel filter assembly 140 includes a standpipe arrangement 200. The standpipe arrangement 200, in this embodiment, is a generally tubular structure 201, illustrated as a standpipe member 204. The standpipe member 204 allows for the directing of cleaned fluid into the appropriate channels through the cleaned fluid outlet port 156.

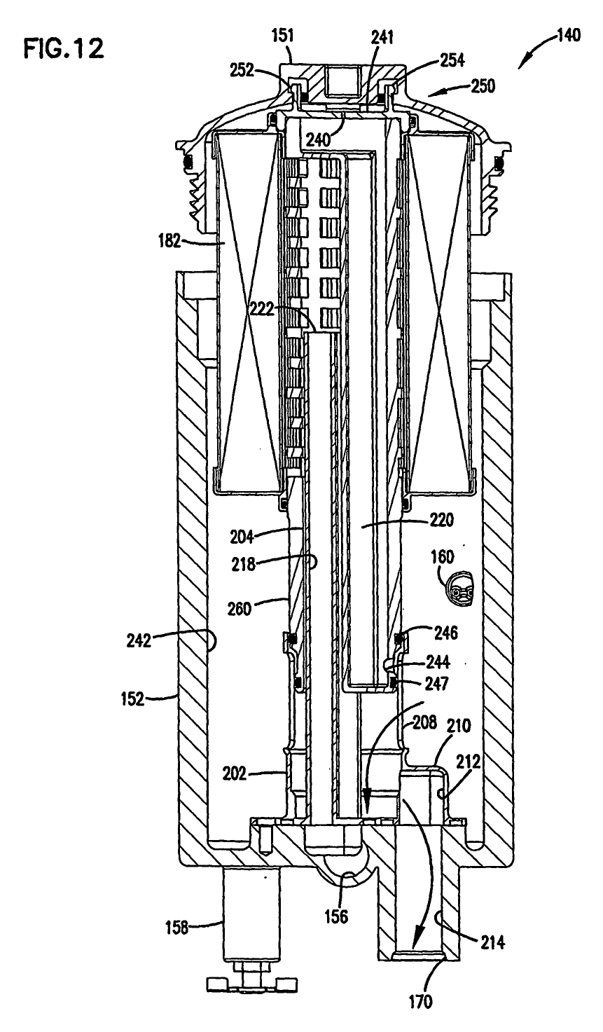

Still in reference to FIG. 9, circumscribing the standpipe member 204 is tubular member 202. Tubular member 202 includes a side wall 206 defining a fluid opening 208. The fluid opening 208 is exposed to allow for the drainage of unfiltered fluid from the upstream side of the filter media 180 and eventually through the appropriate channels to the drainage port 170, during servicing. Although explained in more detail below, FIG. 12 illustrates the fluid opening 208 exposed and allowing the flow of unfiltered fluid therethrough.

In FIGS. 10 and 11, it can be seen that the tubular member 204 helps to support the filter cartridge 172 axially within the housing. The filter cartridge 172, in certain systems, especially convenient for fuel filter systems, is preferably spaced within the housing 152 to allow for the presence of cavity 184 to collect fluid (for example, water that has been separated from fuel). To provide the axial support within the housing 152, the tubular member 202 extends from the housing bottom 186 a certain predetermined distance. The distance is determined based upon how much volume is desired for fluid collection cavity 184. In FIGS. 10 and 11, the axial end 203 of the tubular member 202 can be seen engaging the seal ring holder 194 of the filter cartridge 172. This physical engagement between the filter cartridge 172 and the tubular member 202 helps to provide axial support of the filter cartridge 172 within the housing 152. In other words, the end 203 of the tubular member 202 functions as a stop for the filter cartridge 172.

Still in reference to FIG. 9, projecting from the sidewall 206 of the tubular member 202 is a side conduit member 210. The side conduit member 210 is part of a venting feature and draining feature, explained below. The side conduit member 210 defines an open channel 212 (FIGS. 11 and 12) that is in communication with the drainage channel 214 which terminates at the drain port 170.

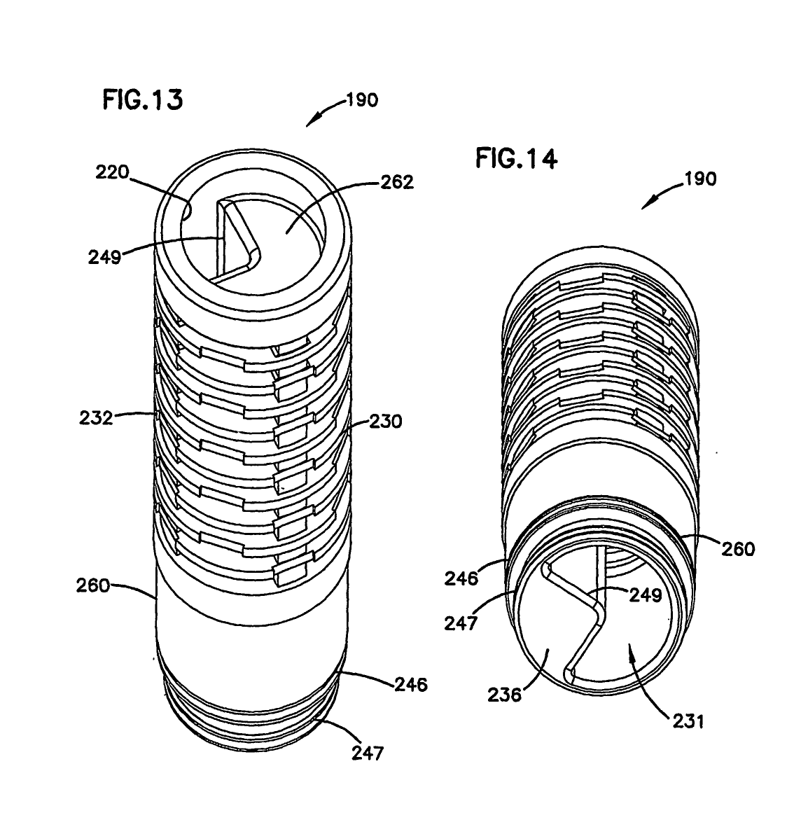

Still in reference to FIG. 9, the standpipe member 204 is a non-circular member 216 defining a clean flow fluid channel 218 (FIG. 10) therewithin. The non-circular member 216 is shaped in order to cooperate with the center tube 190 and allow for the flow of clean fluid into the fluid channel 218, while allowing for the passage of a venting channel 220 (FIGS. 11 and 13) defined by the center tube 190. In the embodiment shown, the standpipe 204 has a cross-sectional shape that is similar to a rounded V or a somewhat flattened U, or a banana. While a variety of shapes to the profile of standpipe 204 could be used, again, the reason for the irregular shape is to allow for the existence of the venting channel 220.

The standpipe member 204 has an open end 222 that allows for the flow of cleaned fluid into the clean flow fluid channel 218. Opposite to the open end 222 is a second open end 224 (FIG. 10), which is in communication with the channel 226 that terminates in the outlet port 156. In FIG. 10, it can be seen how fluid is filtered by passing through the pleated media 182, through a porous part of the center tube 190, through the open end 222 of the standpipe member 204, into the clean fluid flow channel 218, out through the open end 224, into the channel 226, and out through the outlet port 156.

In reference now to FIGS. 9-14, the center tube 190 is described in further detail. The center tube 190 in this embodiment is different from the center tube 30 in the previous embodiment. The center tube 190 in this embodiment is configured to allow for an automatic venting feature for the fuel filter assembly. Venting is needed in fuel filter assemblies 140 because air gets into a fuel system in two ways. First, air is mixed into many types of fuels. During use, it will separate and rise to the top of the filter assembly 140. The second way that air gets into the fuel filter system 140 is during servicing. When the service cover 150 is replaced onto the housing 152, air is trapped within the housing 152. It is undesirable to have air directed to the fuel injectors. Thus, the fuel filter system 140 is designed to have an automatic venting system 228 (FIG. 11). The venting system 228 allows for the directing of any air that has collected toward the top part 221 (FIG. 11) of the housing 152, along with some liquid (fuel) to bypass the media 180 and be directed into the venting channel 220 and into the drainage channel 214.

In FIG. 11, it can be seen that the center tube 190 has an outer wall including both a porous portion 230 and a non-porous portion 232. The porous portion 230 defines an inner channel 231 (FIG. 14) and cooperates with the standpipe member 204 in order to direct the flow of filtered fluid into the open end 222 and into the clean flow fluid channel 218. The non-porous portion 232 forms the venting channel 220. The venting channel 220 extends from partially closed end 234 of the center tube 190 to the opposite end 236 (FIGS. 11 and 14). The partially closed end 234 is a wall 238 with a bleed hole 240. Note that FIGS. 13 and 14 show the center tube 190 without end piece 241 connected thereon. End piece 241 includes wall 238 with bleed hole 240. The bleed hole 240 allows for fluid communication between the venting channel 220 and the unfiltered fluid volume 242 on the upstream side of the filter media 180. Note that the bleed hole 240 is near or at the top of the fuel filter assembly 140 in order to be in the closest proximity to any air that is in the housing 152.

In FIGS. 9 and 11, it can be seen that the center tube 190 defines a venting flow aperture 244 near the end 236. The venting flow aperture 244 provides fluid flow communication between the venting channel 220 and the side conduit member 210. The center tube 190 has a pair of seal members 246, 247 that provide seals between the center tube 190 and portions of the tubular member 202 around the side conduit member 210. The seal members 246, 247 ensure that the drainage channel 214 is otherwise sealed closed to the flow of other fluid within the housing 152 during filtration operation. The seal members 246 and 247 are released during servicing to allow for the opening of the drainage channel 214 to the unfiltered fluid.

In reference now to FIGS. 13 and 14, in the embodiments shown, it can be seen that the center tube 190 has a wall or partition 249 that divides the center tube 190 between its venting channel 220 and its inflow channel 231. The partition 249 forms a cross-sectional shape that matches the profile shape of the standpipe member 204. In the embodiment shown, this shape is a rounded V-shape, a flattened U-shape, or a banana shape. Of course, other shapes are possible. From reviewing FIGS. 11-14, it can also be seen that there is a section 260 of the center tube 190 that is non-porous. This section 260 is sized to be a part of the section that is between where the filter cartridge 172 is mounted and the bottom end 186 of the housing 152. With the exception of the venting hole aperture 244, section 260 is non-porous. In FIG. 13, it can also be seen how the inflow channel 231 has an end wall 262 in order to prevent the flow of unfiltered liquid from the venting channel 220.

By reviewing FIG. 11, it can be seen how a fraction of fluid, including any air mixture, in the unfiltered fluid volume 242 is allowed to bypass the filter media 180 and flow through the bleed hole 240. From there, it flows into the venting channel 220 and out of the center tube 190 through the venting flow aperture 244. From there, it flows into the side conduit member 210 and then through the drainage channel 214 and drain port 170.

As with the first embodiment, the fuel filter assembly 140 includes a snap-ring arrangement 250 between the center tube 190 and the service cover 150. The snap-ring arrangement 250 allows for the service cover 150 to be rotated, while the center tube 190 remains stationary. The snap-ring arrangement 250 also allows for the removal of the center tube 190 when the service cover 150 is removed. When the service cover 150 is removed, the snap-ring arrangement 250 holds the center tube 190 with it, which also pulls out the filter cartridge 172. The snap ring arrangement 250 includes a slide ring 252 on the service cover 150 and a plurality of hooked flanges 254 in mating engagement with the slide ring 252. The hooked flanges 254 are spaced apart to allow for the flow of fluid therebetween in order to reach the bleed hole 240. In the illustrated embodiment, the hooked flanges 254 are part of the end piece 241, and extend from the wall 238.

In operation, the fuel filter assembly 140 works as follows. Fluid to be filtered enters the assembly 140 through the inlet port 154. From there, it flows into the unfiltered fluid volume 242. The fluid, in this example fuel, flows through the filter media 180. Any water in the fuel is separated from the fuel and drains by gravity into the cavity 184 underneath the cartridge 172. Eventually, the water level sensor 160 will indicate that the fuel filter system 140 needs draining, and the drain valve 158 is opened to allow for the draining of water from the cavity 184.

The unfiltered fuel passes through the filter media 180 and flows through the porous portion 230 of the center tube 190. From there, the filtered fuel flows through the open end 222 of the standpipe member 204. The cleaned fuel then flows into the clean flow fluid channel 218, into channel 226, and is directed out of the housing 152 through the outlet port 156.

During operation, a certain amount of the fuel that may contain air collects at the top 221 of the housing 152. This air, fuel, or air/fuel mixture passes between the hooked flanges 254 and into the bleed hole 240. From there, the fluid travels in the venting channel 220 (FIG. 11) and passes through the venting flow aperture 244. The fluid then flows into the side conduit member 210, into channel 212 and into the drainage channel 214. The fluid exits the draining channel 214 through the drain port 170. Other fluid in the housing 152 is prevented from passing through the drainage channel 214 by the existence of seal members 246 and 247.

To service the fuel filter assembly 140, the service cover 150 is removed from the housing 152. This is done by rotating the service cover 150 relative to the housing 152 to release the threaded engagement 168. As the service cover 150 is rotated, the center tube 190 remains stationary and does not rotate due to the snap-ring arrangement 250. As the service cover 150 and center tube 190 are removed linearly or axially outwardly from the housing 152, the seals 246, 247 are released to open the drainage channel 214. Unfiltered fuel passes from unfiltered liquid volume 242, through the fluid opening 208 in the tubular member 202, into the side conduit member 210, into the drainage channel 214, and exits the housing 152 through the drain port 170. Any of the filtered fuel remains in the standpipe member 204 or slowly drains through the clean fluid flow channel 218 and through the outlet port 156. Any of the fluid that was in the venting channel 220 flows through the drainage channel 214 and exits the housing 152 through the drain port 170.

The service cover 150 with the center tube 190 and the filter cartridge 172 secured thereto is then completely removed from the housing 152. The filter cartridge 172 is replaced by releasing the seals 196, 197 from the center tube 190 by pulling the filter cartridge 172 off of the center tube 190. A new filter cartridge 172 is then mounted onto the center tube 190. This is done by sliding the new filter cartridge over the center tube 190 until seals 196, 197 operably mounted in place on the center tube 190.

The service cover 150 with the center tube 190 and the new filter cartridge 172 secured thereto is then operably oriented into the housing 152. This is done by placing the center tube 190 relative to the standpipe arrangement 200 so that it is within and circumscribed by the tubular member 202 but outside of the standpipe member 204. The threaded engagement 168 is resecured by rotating the service cover 150 relative to the housing 152. Again, this rotates the service cover 150 but does not rotate the center tube and filter cartridge 172 due to the snap-ring arrangement 250. The threads are continued to be engaged until the seals created by seal members 246, 247 are created which close off the drainage channel 214 to the flow of unfiltered fluid. The drainage channel 214 is open to a small amount of flow through the venting channel 220. The filter assembly 140 is once again ready for filtration.

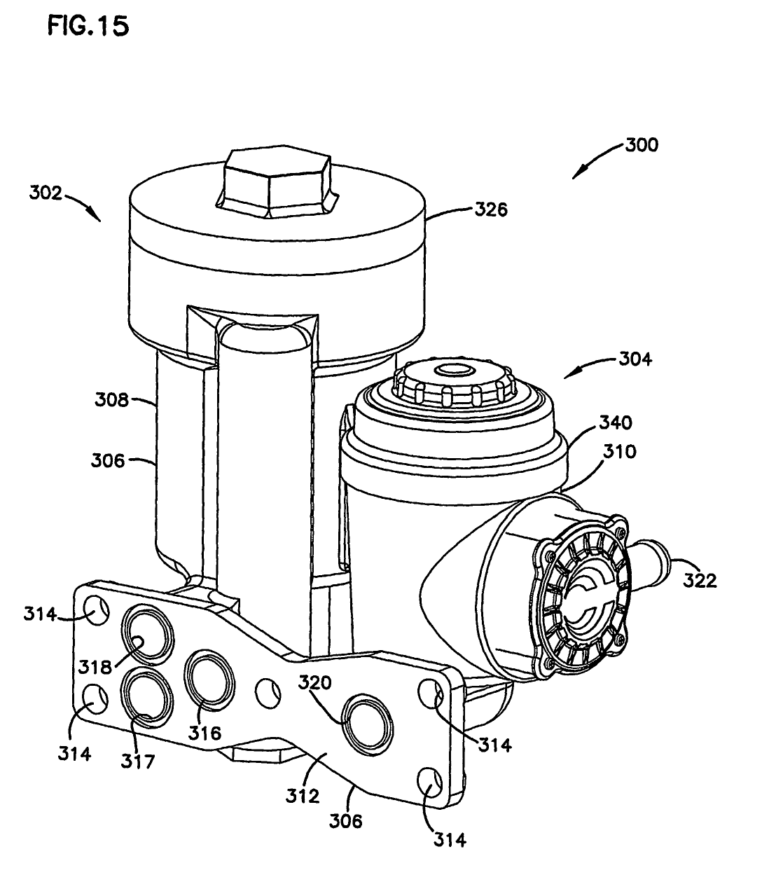

### C. The Embodiment of FIGS. 15-17

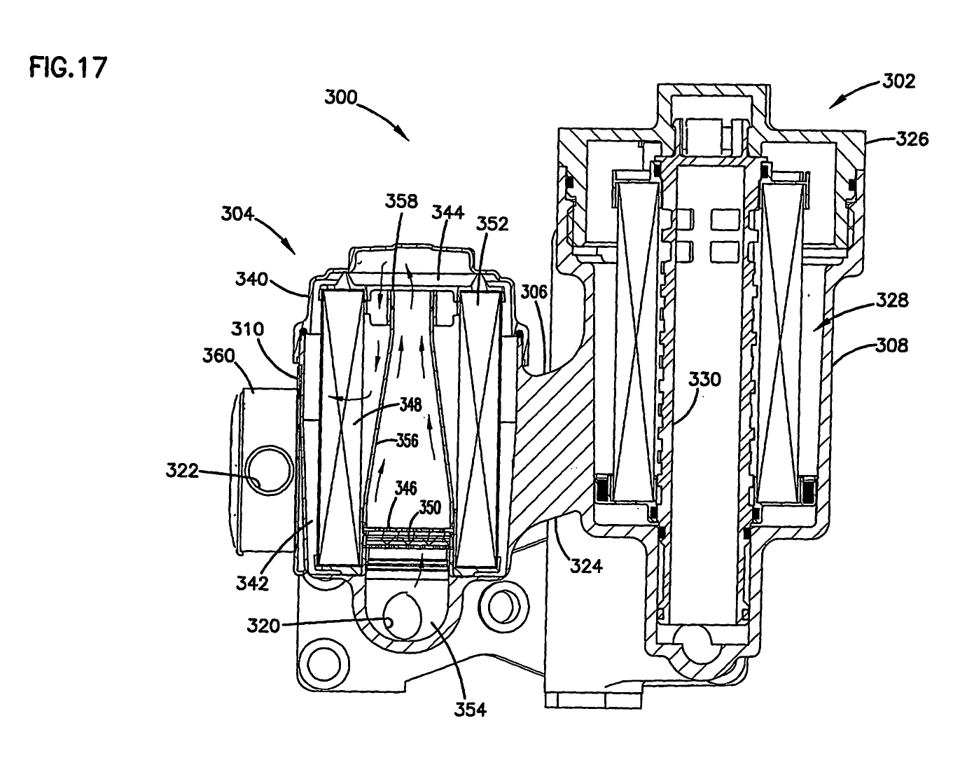

In FIGS. 15-17, there is an assembly 300 including a filter assembly 302 and a crankcase ventilation filter 304 made from a single housing 306. The filter assembly 302 can be any of the types of filter assemblies discussed herein, including the filter assembly 20. The filter assembly 302 and the crankcase ventilation filter 304 are located adjacent to each other (e.g., less than 12 inches, typically less than 6 inches apart), such that the housing 306 can be made from a single, common tool. In the embodiment shown, the filter assembly 302 has a housing 308, while the crankcase ventilation filter 304 has a housing 310. Together, the housing 308 and housing 310 make up the housing 306. In the embodiment shown, there is no common filtration chamber between the filter assembly 302 and crankcase ventilation filter 304. Rather, it is the housings 308, 310 that are manufactured together, from a single tool, that makes up housing 306. This can be seen in FIG. 17.

The housing 306 includes a mounting flange 312. The mounting flange 312 is to enable mounting of the assembly 300 onto an engine block to allow for the appropriate inputs and outputs between the engine and the filter assembly 302 and crankcase ventilation filter 304. The mounting flange 312 includes mounting apertures 314 to accept bolts or other suitable fasteners in order to mount the assembly 300. Also viewable in FIG. 15, the mounting flange 312 has an inlet port 316, an outlet port 317, and a drain port 318. The inlet port 316 allows for the flow of fluid, such as oil, into the filter assembly 302. The filter assembly 302 contains filter cartridges, such as filter cartridge 28, which cleans the fluid. The cleaned fluid is then conveyed through the outlet port 317 for use by the engine. When servicing the filter assembly 302, the drain port 318 allows for the draining of fluid from the filter assembly 302.

The mounting flange 312 also defines an inlet port 320 for communication with the crankcase ventilation filter 304. Blow-by gases from the engine crankcase are directed through the inlet port 320 and into the crankcase ventilation filter 304. Blow-by gases are filtered, and cleaned gases are directed from the crankcase ventilation filter 304 through a gas outlet port 322.

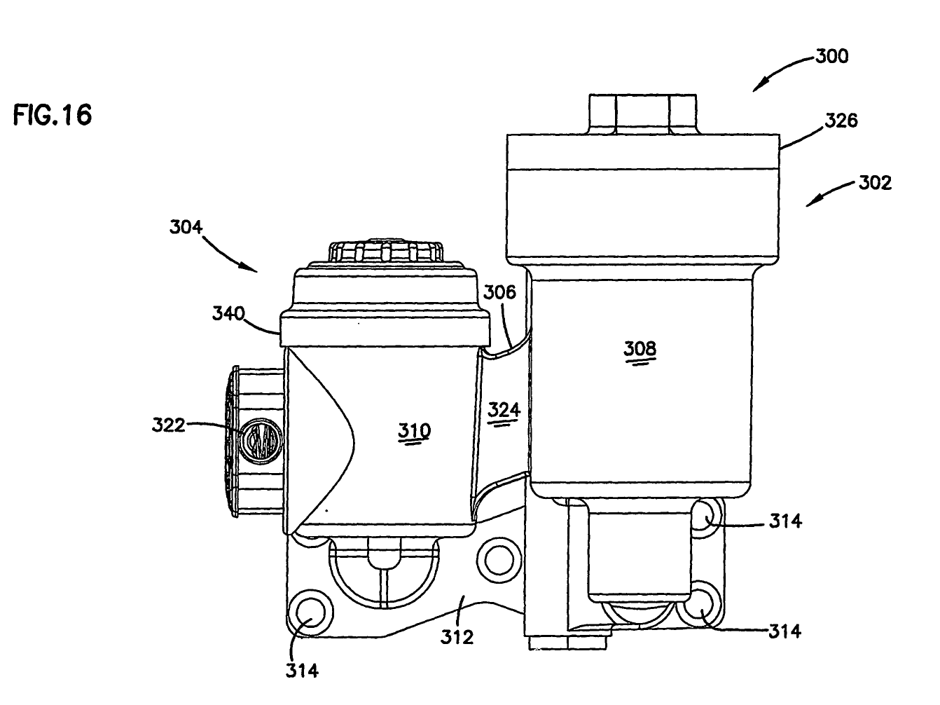

In FIG. 16, it can be seen how the common housing 306 includes a flange 324 that connects the housing 308 to the housing 310.

The filter assembly 302 can be constructed as described with respect to FIGS. 2-6, above. As such, the filter assembly 302 that is illustrated has a service cover 326 threadably mated to the housing 308. In FIG. 17, it can be seen how the filter assembly 302 has a filter cartridge 328 operably mounted on a center tube 330. The cover 326 with the center tube 330 attached can be removed from the housing 308 in order to service the filter assembly 302. The filter cartridge 328 is removable from the center tube, so it can be replaced.

The crankcase ventilation filter 304 shown can be the type that is described in pending PCT application, Serial No. US03/36835, filed Nov. 17, 2003, which claimed priority to U.S. Provisional Patent Application Ser. No. 60/427,510, filed Nov. 18, 2002. Each of these patent applications is incorporated herein by reference. In general, the crankcase ventilation filter 304 filters blow-by gases from the crankcase by coalescing any oil in the gases and then removing any debris from the remaining gases. The coalesced oil is returned to the crankcase, while the filtered gases are generally directed back into the engine air cleaner.

In FIG. 17, the internal components of one example embodiment of the crankcase ventilation filter 304 are shown. The crankcase ventilation filter 304 that is illustrated includes a service cover 340 secured to the housing 310. The service cover 340 can be removed from the housing 310 in order to service the crankcase ventilation filter 304. The embodiment shown in FIG. 17 illustrates the crankcase ventilation filter 304 as being a top-load arrangement.

Within the housing 310, there is a removable and replaceable filter element 342. The filter element 342 that is shown is a two-stage filter element 344. The first stage, shown at 346, functions to coalesce oil or any liquid in the blow-by gases. The second stage, shown at 348, functions to remove particulate and any debris from the gas. In preferred embodiments, the first stage 346 comprises a fibrous bundle of depth media 350, and the second stage 348 comprises a tubular region of pleated media 352.

The crankcase ventilation filter 304 operates to receive blow-by gases from the engine crankcase through the inlet port 320. From there, it is directed through the first stage 346. The first stage 346 operates to coalesce any liquid, such as oil, from the blow-by gases. Any of the coalesced liquid drips down by gravity back into the region 354 where it is usually drained to an oil sump or the crankcase. From the first stage 346, the gases continue flowing through an impermeable inner tube 356. From there, the gases emerge from the end 358 of the tube 346, flow around the end 358, and enter the passageway between the upstream side of the second stage media 348 and the tube 356. From there, the gas flows through the pleated media 352 where it is cleaned of contaminant and debris. The cleaned air through flows into region 360 and out through the gas outlet port 322. The region 360 may contain valving structure.

1-24. (canceled)

25. A method for servicing a fluid filter assembly; the fluid filter assembly having a housing with a removable service cover and a removable and replaceable filter cartridge in the housing; the method comprising:
(a) removing the service cover from the housing to remove, together with the service cover, a center tube, and open a drainage flow passageway from the housing;
(i) the step of removing, together with the service cover, a center tube includes removing the filter cartridge from the housing; the filter cartridge being removably attached to the center tube;
(A) the filter cartridge including:
(1) a tubular construction of filter media;
(2) first and second end caps with the filter media extending therebetween;
(3) a first ring integral with the first end cap and projecting above the first end cap;
(4) a second ring integral with the second end cap and projecting below the second end cap;
(5) a first seal member adjacent to the first end cap held by the first ring and providing a first removable seal between the filter cartridge and the center tube; and
(6) a second seal member adjacent to the second end held by the second ring and providing a second removable seal between the filter cartridge and the center tube;
(b) removing the filter cartridge from the center tube by releasing the first removable seal and the second removable seal between the filter cartridge and the center tube;
(c) operably mounting a new filter cartridge on the center tube;
(d) operably mounting the service cover, together with the center tube having the new filter cartridge thereon, in the housing to close the drainage flow passageway.

26. A method according to claim 25 wherein:
(a) the step or removing, together with the service cover, the center tube to open a drainage flow passageway from the housing includes:
(i) moving the center tube to release a seal arrangement between the center tube and portions of the housing to open the drainage flow passageway from the housing.

27. A method according to claim 26 wherein:
(a) the step of moving the center tube to release a seal arrangement between the center tube and portions of the housing to open the drainage flow passageway from the housing includes:
(i) moving the center tube relative to a tubular member within the housing to release a seal between the center tube and the tubular member and allowing fluid to drain through the drainage flow passageway.

28. A method according to claim 25 wherein:
(a) the step of removing the service cover from the housing to remove, together with the service cover, a center tube, includes rotating the service cover relative to the housing while the center tube remains rotationally stationary.

29. A method according to claim 28 wherein:
(a) the center tube is secured to the service cover with a snap ring arrangement; and
(b) the step of removing the service cover from the housing to remove, together with the service cover, a center tube, includes rotating the service cover relative to the housing to allow the snap ring arrangement on the center tube to slide along a slide ring surface on the service cover so that the center tube remains rotationally stationary when the service cover is rotated.

30. A method according to claim 25 wherein:
(a) the step of removing the service cover from the housing to remove, together with the service cover, a center tube, includes releasing a threaded engagement between the service cover and the housing by rotating the service cover relative to the housing.

31. A method according to claim 25 wherein:
(a) removing the filter cartridge from the center tube includes sliding the filter cartridge off of the center tube.

32. A method according to claim 31 wherein:
(a) the step of removing the filter cartridge from the center tube includes releasing the first removable seal formed by the first seal member held by the first ring and releasing the second removable seal formed by the second seal member held by the second ring.

33. A method of filtering using a filter housing having a removable and replaceable filter cartridge; the filter housing having removable a service cover providing access to the filter cartridge; the method comprising:
(a) directing fluid to be filtered:
(i) into the housing having the removable and replaceable filter cartridge; the filter cartridge having a tubular region of filter media; the tubular region of filter media being mounted on a center tube with an impermeable wall and fluid openings in a portion of the wall;
(A) the center tube being removable with the service cover;
(B) the filter cartridge including:
(1) first and second end caps with the filter media extending therebetween;
(2) a first ring integral with the first end cap and projecting above the first end cap;
(3) a second ring integral with the second end cap and projecting below the second end cap;
(4) a first seal member adjacent to the first end cap held by the first ring and providing a first removable seal between the filter cartridge and the center tube; and
(5) a second seal member adjacent to the second end held by the second ring and providing a second removable seal between the filter cartridge and the center tube;
(ii) through the tubular region of filter media;
(iii) through the fluid openings in the center tube wall; and
(iv) into a clean fluid flow passageway;
(b) preventing fluid to bypass the filter media by removably sealing the filter cartridge to the center tube with the first and second removable seal; and
(c) preventing fluid from flowing into a drainage passageway by removably sealing the center tube to other portions of the filter housing.

34. A method according to claim 33 wherein:
(a) the step of preventing fluid from flowing into a drainage passageway by removably sealing the center tube to other portions of the filter housing includes removably sealing the center tube to a tubular member mounted within the filter housing.

35. A method according to claim 34 further comprising:
(a) allowing a fraction of unfiltered fluid to bypass the filter media and flow into the drainage passageway.

36. A method according to claim 35 wherein:
(a) the center tube has a partition dividing between a filtered fluid volume and an unfiltered fluid volume; and
(b) the step of allowing a fraction of unfiltered fluid to bypass the filter media and flow into the drainage passageway includes directing the unfiltered fluid into the unfiltered fluid volume through an opening between the center tube and the service cover.

37. A fluid filter assembly comprising:
(a) a housing defining a sidewall with an interior volume, an open access mouth, an inlet channel in communication with the interior volume, an outlet channel, and a drainage channel;
(i) the inlet channel allowing fluid to be cleaned to enter into the housing interior;
(ii) the outlet channel providing an exit path for cleaned fluid out of the housing; and
(iii) the drainage channel providing an exit path for fluid out of the housing;
(b) a service cover removably mounted onto the housing to cover the access mouth;
(c) a center tube removably secured to the service cover; the center tube having an impermeable wall and fluid openings in a portion of the wall;
(i) the fluid openings being in communication with the outlet channel;
(d) a filter cartridge removably sealed to and circumscribing the center tube; the filter cartridge including:
(i) a tubular construction of filter media;
(ii) first and second end caps with the filter media extending therebetween;
(iii) a first ring integral with the first end cap and projecting above the first end cap;
(iv) a second ring integral with the second end cap and projecting below the second end cap;
(v) a first seal member adjacent to the first end cap held by the first ring and providing a first removable seal between the filter cartridge and the center tube; and
(vi) a second seal member adjacent to the second end held by the second ring and providing a second removable seal between the filter cartridge and the center tube;
(e) a seal arrangement between the center tube and portions of the housing to close the drainage channel to clean fluid flow when the fluid filter assembly is operating to filter;
wherein fluid flows into the housing through the inlet channel, through the filter cartridge, through the fluid openings in the center tube, and out of the housing through the outlet channel.

38. A fluid filter assembly according to claim 37 wherein:
(a) the seal arrangement between the center tube and portions of the housing includes first and second seal members circumscribing the center tube to provide a first and second seal between the center tube and the housing adjacent to the drainage channel.

39. A fluid filter assembly according to claim 37 wherein:
(a) the filter cartridge includes a first ring integral with the first end cap and projecting above the first end cap; the first seal member being held by the first ring; and
(b) the filter cartridge includes a second ring integral with the second end cap and projecting below the second end cap; the second seal member being held by the second ring.

40. A fluid filter assembly according to claim 37 wherein:
(a) the filter cartridge includes a tubular construction of pleated filter media.

41. A fluid filter assembly according to claim 37 wherein:
(a) the service cover and center tube are rotationally connected together with a snap ring assembly.

42. A fluid filter assembly according to claim 41 wherein:
(a) the snap ring assembly includes:
(i) an internally directed slide ring on the service cover; and
(ii) a plurality of hooked flanges on the center tube in snap engagement with the slide ring.

43. A fluid filter assembly according to claim 41 wherein:
(a) the service cover is threadably connected to the housing; and
(b) the snap ring assembly is constructed and arranged to ensure that when the service cover is rotating relative to the housing, the center tube is stationary.

44. A fluid filter assembly according to claim 37 wherein:
(a) the center tube is longer than the filter cartridge.

45. A fluid filter assembly according to claim 37 further comprising:
(a) a second filter assembly constructed and arranged to filter blow-by gases from an engine crankcase; the filter assembly including a two-stage filter element operably mounted within a housing;
(i) the second filter assembly housing being a same common housing as the fluid filter assembly housing.

46. A fluid filter assembly according to claim 37 further comprising:
(a) a standpipe arrangement in the housing; the standpipe arrangement including a standpipe member with a non-circular cross-section; the standpipe member defining an inner standpipe fluid channel in flow communication with the outlet channel.

47. A fluid filter assembly according to claim 46 wherein:
(a) the center tube includes a partition dividing the center tube into first and second flow channels;
(i) the first flow channel being in fluid communication with the inner standpipe fluid channel; and
(ii) the second flow channel being in fluid communication with an unfiltered fluid volume upstream of the filter cartridge and the drainage channel.

48. A fluid filtration system comprising:
(a) an engine utilizing fluid to operate; and
(b) a fluid filter assembly according to claim 37 operably installed to clean the fluid utilized by the engine.
